(19) United States
(12) Patent Application Publication
(10) Pub. No.: US 2006/0283086 A1
(43) Pub. Date: Dec. 21, 2006

(54) Air release

(76) Inventor: John Rittie, Kingston, NY (US)

Correspondence Address: JOHN MAIER, III, 660 AARON COURT, KINGSTON, NY, 12401, US

(21) Appl. No.: 11/153,589

(22) Filed: Jun. 15, 2005

(51) Int. Cl. E06B 7/00; E06B 7/14

(52) U.S. Cl. 49/70; 49/408

(57) ABSTRACT

An Air Release is provided having an outer end and an inner end for installation in a storm door to release air between the storm door and an adjacent main door. An outer member includes a tube with an exterior surface, an outer collar mounted on the tube at the outer end and an outer flange against the outer collar toward the inner end. The tube has a thread on its exterior extending from the inner end toward the outer flange. A flap is mounted to swing in the outer collar of the outer member and stop in the outer member adjacent the flap toward the inner end prevents the flap from swinging toward the inner end. An outer washer is located adjacent to the outer flange toward the inner end. An inner member includes a inner collar having an interior thread which mates with the external thread of the tube to engage the thread on the tube. An inner flange is located against the inner collar toward the outer end. Grip plates extend diagonally from the inner collar across the inner flange. An inner washer is located adjacent to the inner flange toward the inner end.

### BACKGROUND OF THE INVENTION

1. Field of the Invention

This invention relates to an air release and, more specifically, to an air release for use in a door to release the air between an inner and outer door adjacent one another,

2. Prior Art

Today, the use of storm doors to save heat is commonplace. A storm door is placed in the door frame toward the outside of a building. A door, which is a regular entrance door is placed at the inside of the door frame. When both doors are closed and either one of the doors is opened, difficulty in opening the door occurs due to the vacuum lock between the doors. Similarly, when attempting to close a door, the door resists being closed due to the inability of air to escape as the door is closed. Particularly with storm doors, the door is left ajar due to the inability of the door to readily close from the air being compressed between the doors. As a result, if there is a strong wind, the storm door is blown open which can easily result in damage. The problem of forcing the door closed is particularly perplexing to an older person or someone who is physically challenged.

### OBJECTS

The objects of this invention are as follows:

1. The provide an air escape to be mounted in a door to release the air lock between two contiguous doors.

2. To provide an air release to release the air between two contiguous doors that is simple, dependable and economical.

3. To provide an air release that can be easily installed.

These and other objects of the present invention will become apparent upon further review of the following representations and drawings.

### SUMMARY OF THE INVENTION

An Air Release has an outer end and an inner end for installation in a storm door for releasing air between the storm door and an adjacent main door. An outer member includes a tube with an external thread on the tube and an outer collar and an outer flange at the outer end. An inner member including an inner collar and an inner flange engages the thread on the tube. Means are included to restrict the direction of the flow of air substantially from the inner end to the outer end.

### BRIEF DESCRIPTION OF THE DRAWINGS

FIG. 1 is a pictorial view of an entrance door in a building with a storm door mounted in the same door frame with the storm door open and with an air release mounted in the door.

FIG. 2 is an exploded pictorial view of the air release as it is mounted on a door.

FIG. 3 is a pictorial view of the inside end of an air release mounted in a storm door.

FIG. 4 is a cross sectional view of the air release fully assembled in a door.

FIG. 5 is a front elevation of the front of the air release showing the flap used to seal the air release.

### BRIEF DESCRIPTION OF THE NUMERALS

| NUMERAL | DESCRIPTION |
|---|---|
| 11 | Doorway |
| 13 | Main or Entrance Door |
| 15 | Storm Door |
| 17 | Inside Corner |
| 19 | Inside |
| 21 | Inner End |
| 22 | Outer End |
| 23 | Outside |
| 25 | Opening |
| 29 | Outer Member |
| 31 | Tube |
| 32 | External Thread |
| 33 | Inner End |
| 35 | Outer Collar |
| 37 | Outer Flange |
| 39 | Outer Washer |
| 41 | Inner Member |
| 43 | Inner Collar |
| 45 | Inner Flange |
| 47 | Grip |
| 49 | Internal Thread |
| 51 | Inner Washer |
| 53 | Outer Surface |
| 55 | Flap |
| 57 | Stop |
| 59 | Clip |

### DETAILED DESCRIPTION OF THE PREFERRED EMBODIMENT

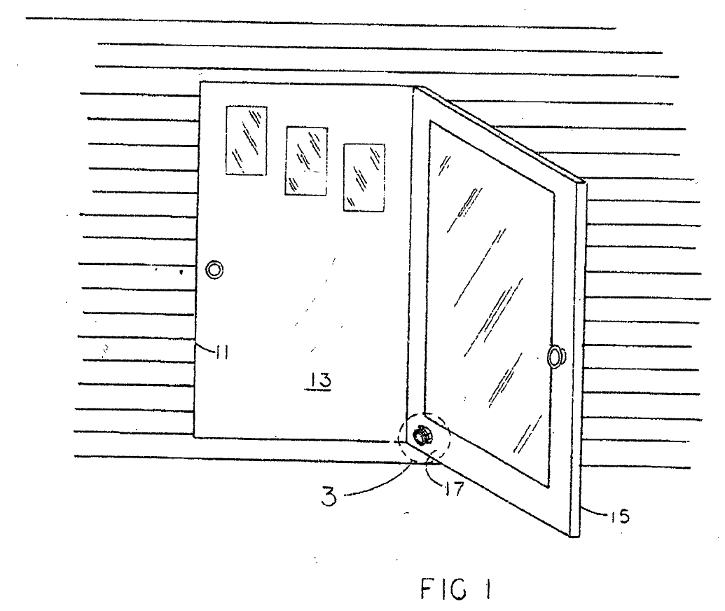

Referring now to FIG. 1, a doorway 11 is shown with a main or entrance door 13 closed. The main door 13 is the inner door 13 usually having a comparatively substantial structure. On the outside of the entranceway 11, a storm door 15 is shown in an open position. The storm door 15 is usually of a much lighter construction than the main door 13. Frequently, the storm door 15 is made of aluminum and does not provide the security against illegal entry that the main door 13 provides. Situate in the lower inside corner 17 of the storm door 15 an Air Release is shown in the storm door 15. The storm door 15, as shown, is largely glass which requires that the Air Release be placed in some location in the storm door 15 outside the glass. However, the Air Release may be placed in any location on the storm door 15 that is convenient.

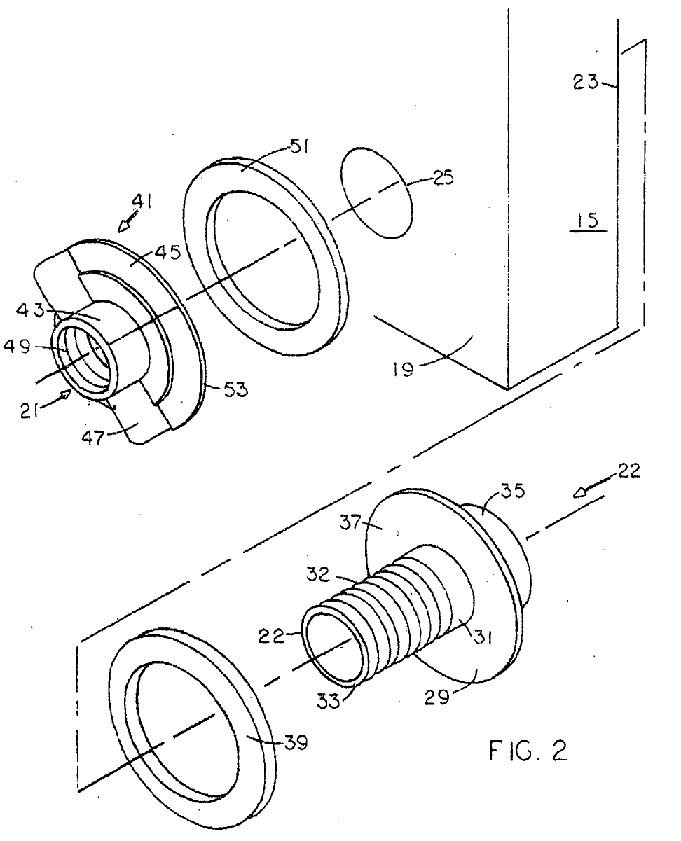

Now referring to FIG. 2, the details of construction of the Air Release are shown. A piece of the storm door 15 is shown with the inside 19 of the storm door 15 and the inner end 21 of the Air Release shown above the outer end 22 of the Air Release. The inside 19 of the storm door 15 faces the main door 13 and the outside 23 of the storm door 15 faces away from the main door 13. An opening 25 must be drilled through the storm door 15 to provide access for the Air Release. At the outer end 22 of the Air Release is the outer member 29. The outer member 29 includes a tube 31. At an outer end 33 of the tube 31 is a collar 35. The outer end 33 of the tube 31 is the same as the outer end 22 of the Air Release. On the inner end 21 of the outer collar 35 is an outer flange 37. The exterior of he tube 31 has a external thread 32 from the inner end 21 to adjacent the outer flange 37. An outer washer 39 is mounted against the outer flange 37 and against the storm door 15.

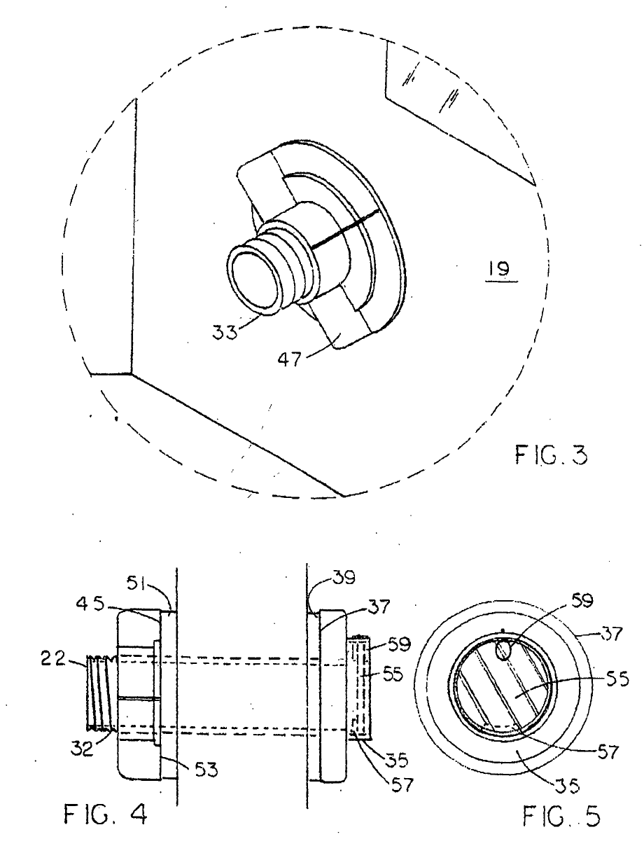

An inner member 41 is situated at the opposite side or the inside of the storm door 15. The inner member 41 includes an inner collar 43 and an inner flange 45 located adjacent the inner collar 43 toward the outer member 29. A pair of grips or grip plates 47 extend diagonally from the inner collar 43 and along the inner flange 45. The inner collar 43 has an internal thread 49 that matches the external thread 32 on the outer member 29. An inner washer 51 is located against an outer surface 53 of the inner flange 45 and (FIG. 3) between the storm door 15 and the inner flange 45.

As shown in FIG. 4 and FIG. 5, a flap 55 is located at the outer end 22 within the outer collar 35. A stop 57 adjacent the flap 35 just slightly toward the Inner end 21 prevents the flap 55 from rotating toward the inner end 21 thus preventing outside air from blowing through the Air Release from the outer end 22 while permitting the flap 55 to rotate outwardly to release air between the storm door 15 and the main door 13. The flap 55 is secured to the outer collar 35 in the outer member 29 by a clip 59. The clip 59 need not bend if the flap 55 is sufficiently flexible to bend to release the air between the storm door 15 and the main door 13.

It is to be understood that the drawings and descriptive matter are in all cases to be interpreted as merely illustrative of the principles of the invention, rather than as limiting the same in any way, since it is contemplated that there are various elements to achieve like results without departing from the spirit of the invention or the scope of the appended claims.

1. An Air Release having an outer end and an inner end for installation in a storm door for releasing air between the storm door and an adjacent main door, such Air Release comprising:
an outer member including a tube with an external thread on the tube and an outer collar and an outer flange at the outer end;
an inner member including an inner collar and an inner flange to engage the thread on the tube; and
means to restrict the direction of the flow of air substantially from the inner end to the outer end.

2. An Air Release according to claim 1 wherein the means to restrict the flow of air includes a flap.

3. An Air Release according to claim 1 wherein the outer collar is mounted on the tube at the outer end.

4. An Air Release according to claim 1 wherein the inner flange is mounted against the inner collar toward the outer end.

5. An Air Release according to claim 1 wherein the inner flange is mounted against the inner collar toward the outer end and further includes grip plates extending diagonally from the inner collar across the inner flanges.

6. An Air Release having an outer end and an inner end for installation in a storm door for releasing air between the storm door and an adjacent main door, such Air Release comprising:
an outer member including:
a tube with an exterior surface and having a thread on the exterior surface with an outer collar mounted on the tube at the outer end and with an outer flange against the outer collar toward the inner end,
means to permit air flow from the inner end to the outer end and to substantially prevent air flow from the outer end ti the inner end;
an inner member including:
a inner collar having an interior thread mating with the external thread of the tube to engage the thread on the tube, and
an inner flange against the inner collar toward the outer end.

7. An Air Release according to claim 6 further including grip plates extending diagonally from the inner collar across the inner flange.

8. An Air Release according to claim 6 wherein the means to prevent air flow from the inner end to the outer end includes a flap.

9. An Air Release according to claim 6 further including:
an outer washer adjacent to the outer flange toward the inner end; and
an inner washer adjacent to the inner flange toward the outer end.

10. An Air Release having an outer end and an inner end for installation in a storm door for releasing air between the storm door and an adjacent main door, such Air Release comprising:
an outer member including:
a tube with an exterior surface,
an outer collar mounted on the tube at the outer end,
a outer flange located against the outer collar toward the inner end,
the tube having a thread on its exterior extending from the inner end toward the outer flange,
a flap mounted to swing in the outer collar of the outer member, and
a stop in the outer member adjacent the flap toward the inner end to prevent the flap from swinging toward the inner end;
an outer washer adjacent to the outer flange toward the inner end; and
an inner member including:
a inner collar having an interior thread mating with the external thread of the tube to engage the thread on the tube,
an inner flange against the inner collar toward the outer end,
grip plates extending diagonally from the inner collar across the inner flange; and
an inner washer adjacent to the inner flange toward the outer end.
